(19) United States
(12) Patent Application Publication
(10) Pub. No.: US 2011/0103274 A1
(43) Pub. Date: May 5, 2011

(54) SIGNAL REPEATER SYSTEM ARRANGEMENT FOR STABLE DATA COMMUNICATION

(76) Inventor: Geir Monsen Vavik, Jonsvatnet (NO)

(21) Appl. No.: 12/918,251

(22) PCT Filed: Feb. 25, 2009
(86) PCT No.: PCT/NO2009/000063

§ 371 Date: Nov. 29, 2010

(30) Foreign Application Priority Data
Feb. 25, 2008 (NO) 20080925

(51) Int. Cl. H04B 3/36

(52) U.S. Cl. 370/293

(57) ABSTRACT

Signal repeater system of the general type that facilitates using various standards and various modulation types to improve properties with various infrastructure, in particular power grid systems.

### SUMMARY

This invention applies to signal repeater systems for telecommunication where the information carrier is alternative, restricted or old infrastructure. One example is the power grids. The invention also applies to improvement of range, coverage, connectivity and stability for data communication over infrastructures. The invention further applies to improvement of bandwidth for telecommunication over infrastructures. The invention would represent a strong contender to fibre to The Home (FTTH) with respect to the gross picture of costs, deployment speed and Quality of Experience.

### BACKGROUND

The background for the invention is described in PCT/NO/2006/00137 and pertaining, relevant documents. When infrastructures as with low voltage and medium voltage grids are to be used as information carrier for PHY in telecommunication systems as with Docsis and DVB, strict specifications for stability are required. Inventions as described in PCT/NO/2006/00137 can facilitate such stability specifications. However, due to variations of the various implementations of power grids still, the stability remains poorer than plain coaxial networks or HFC (Hybrid Fibre Cable) networks even if the stability may prove better than with ADSL in copper networks. This is evident from the bit error rates BER being higher than with coaxial networks. In some cases this turns out as loss of data or jitter for real time protocols as with UDP and RTP. This still offers quite acceptable quality for service flows like Internet, IP voice, Unicast (Video on Demand). This is true also for lesser and medium time critical applications and for Unicast with little or no compression. It is further true for Broadcast using Unicast which thereby has return transmission with CRC checking and repetition of data packets includes buffering. However, the demands are present when using Multicast without the use of return transmission and with a high degree of compression. Example of this is the use of MPEG4, as with IPTV and when short time delays are required as in live Broadcast. Multicast with high definition as with Standard Definition TV and especially High Definition TV can therefore present demands that makes it difficult to ensure a commercially viable product. The use of MPEG4 offers high quality for video streams, but presents higher demands on stability.

At the same time it is costly and comprehensive to undertake development own, proprietary communication layers that will guard against such errors. And it may gain limited use and in particular the client equipment becomes expensive. Wide usage of a technology will depend on unit pricing. In reality this can only be achieved with accepted standards that ensure large production volumes. For standardized systems like cable modem standards as Docsis and DVBx such usage is large, QoS Quality of Service is becoming well implemented and support is available globally. Wide spread usage of such technologies ensures low unit prices for cost critical devices.

Even wireless standards as 802.11x is similarly very exposed to variations in link quality for critical services. Even with upcoming versions of these standards the most demanding service streams will demand a stable link with marginal variations in bandwidth, low BER and low jitter.

Other open standards aimed at alternative infrastructures with the presence of large dispersion, dynamic noise conditions and varying loss conditions fail in realising under practical conditions adequate Quality of Service for critical services. Example of such, open standards is HomePlug AV. Corresponding views are valid also for similar, proprietary standards. A particular problem is variations in bandwidth as well as varying time delays.

Similar analysis are valid also for open and proprietary standards for medium and small bandwidth. Here, similar problems are found for Zigbee and for PLC. For Zigbee and corresponding standards marginal links will force the system to use much of available resources for self configuration and thereby may as an example cause interference with or disruption of real time capacity. For PLC it is also the case that the most noise intensive part of the frequency spectrum is used for communication and that the noise in this frequency region is rather unpredictable. A typical example is noise from a fault under development on a power line becoming sufficiently strong to disable a PLC system which is supposed to warn of and characterize the fault. Low frequency PLC in two way communication (AMR Automated Meter Reading) compelled to use high excitation power which often is impracticable or unrealistic, especially in sensor, actuating and monitoring positions.

When the problems described needs to be addressed with solutions taught in PCT/NO/2006/000137, a critical factor is the industrialized installation part in or on existing infrastructure. This is valid whether we regard low frequency, short wave frequencies, VHF and UHF or microwave.

It exists therefore a need for a technology solution that facilitates the combination of inventions as in PCT/NO/2006/000137 with standardized equipment as with Docsis and DVB without bit error rates BER noticeably deteriorating quality for critical service stream applications keeping delays for real time protocols short. There is a further need for such solutions to become improved with respect to industrial deployment in competition with more expensive, alternative solutions. Consequently there is also a need for novel solutions that avoid installation challenges disrupting the competitive edge of the mentioned solutions.

The background for the invention is also described in publications PCT/NO2001/00079, PCT/NO2003/00004 AND PCT/NO/2005/00013. Here descriptions are given for the foundation of the invention which is to achieve isolation between lines that basically are electrically interconnected yet avoids interference between signals that are not identical or coherent. In mentioned invention this is achieved using ferrite cores, decoupling shunts and by duplex communication base on dividing useful frequency spectrum in different bands for uplink and downlink. In the mentioned inventions is also described one important foundation for the present invention which is incorporating A/D and D/A interfaces in transponders or repeaters that are present at interconnection points in order to condition the infrastructure to optimize the exploitation of mentioned bandwidth. In power grid systems, where useful frequency region is limited with respect to achieving data speeds competitive with FTTH, major challenges persist for exhausting the available bandwidth of the cables themselves.

### OBJECT OF THE INVENTION

The object of the invention is to offer a technological solution that offers the possibility to combine inventions as PCT/NO/2006/00137 with equipment belonging to open standards as for example Docsis and DVB without bit error rates BER and jitter deteriorating the quality of critical service stream applications noticeably. Correspondingly the object of the invention is to be able to accept available and appropriate proprietary standards.

The object of the invention is also in various combinations to facilitate accepting a synergy of standards and thereby improve stability and predictability and at the same time remain within favourable cost budgets.

The object of the invention is to make standardized technology available for use in the most critical service streams over alternative infrastructures that mentioned technologies are not intended for or so called No New Wire concepts. No New Wire concepts may include low voltage grids, high voltage grids, signal wires, control- and surveillance cables and road and street lightening grids. No New Wire concepts may also include no standard signal wires, pipe grids made of plastic or metal that behave as waveguides as described in PCT/NO2006/000137 with relating publications.

The object of the invention is further to apply available, industrialized system components of open or proprietary standards to a largest possible extent when available. This object applies when satisfactory delays, bandwidth and jitter properties is obtainable while retaining the system characteristics of the system components. Examples of such standards are IEEE 802.1x and IEEE 802.16x Wimax.

The object of the invention is correspondingly to offer stable connectivity and bandwidth for open and proprietary standards for medium and narrow bandwidth or systems where real time requirements are moderate. The invention then works either by allowing the use of high carrier frequencies that moves signals away from problematic noise with the help of repeaters. Alternatively it works by offering a low range attenuation along a signal medium in that direct paths or dynamic topology do not become determining. Examples of standards that the inventions can utilize in this way is low frequency PLC and on higher frequencies, IEEE 802.11x and Zigbee (IEEE 802.15.x).

The object of the invention is through standardized equipment to utilize the professional quality offered by this equipment for various functionality like QoS (Quality of Service) for Multicast.

The object of the invention is through standardized equipment to utilize the professional quality offered by this equipment for various functionality like utilizing mesh, grid, star topologies and combinations thereof.

The object of the invention is further to offer novel solutions to ensure competitive deployments. Further the object of the invention encompasses assuring that the improvements of stability and Quality of Service is not compromised following established connectivity to and from Customer Premises (CP) area.

The background for the object of the invention is also described in publications PCT/NO2001/00079, PCT/NO2003/00004, PCT/NO2005/00013 and PCT/NO2006/000137. One object of the invention is to is to provide data communication to as close as possible to the client communication nodes while avoiding influence on stability of data communication from multipath and shadowing problems. One objective of the invention is to exploit and in some cases improve isolation between circuits that are basically interconnected electrically so as to avoid signals that are identical or not coherent interfering with each other. Said objective may apply whether the signals liable to interfere with each other use the same frequency region or use differing frequency regions. It follows that the object of the invention is to prevent cross talk in band and out of band. In referred inventions this is achieved using ferrite cores, decoupling shunts and for duplex communication by dividing useful frequency regions into different bands for upstream and downstream. This gives a further object of the invention which is to exploit said publicized inventions to facilitate becoming able to roughly multiply available bandwidth for one cable with the number of available cables. This will be true for said number of cables despite they being electrically interconnected and not being separable mechanically or galvanic. In said inventions a further and important foundation for the present invention is that A/D and D/A interfaces are incorporated into transponders or repeaters available at interconnecting points in order to condition the infrastructure with the object of optimizing utilization of said bandwidth. A further object of the present invention rests on characteristics of said, publicized inventions where input and output solutions constitute a substantial part for reduction of cross talk and exploitation of the useful bandwidth of the infrastructure or the cables. One characteristic of said object is reliable and easy installations that must not restrain other operations in connection with the infrastructure. One object of the invention is maximum exploitation of the added, analog bandwidth which it offers through utilization of isolation between connection terminals, that is ports. Said exploitation is achieved through amplifying the signals on same frequency not using frequency transposition. Another object of the invention is a novel way of dividing available analog bandwidth into frequency bands with mutual, low cross talk levels according to principles described in PCT/NO2006/000137. A further object of the invention is to utilize advantageous topology of infrastructures as with power grids of utility companies and in buildings with numerous units. In connection with said object it is required to solve the electrical and practical problems occurring in distribution points to be able to achieve a system which is commercially viable and which can be industrialized. A further foundation is given in said, publicized inventions in that they describe use of fibre ring backbone which the present invention can exploit optimally. The present invention achieves this by best possible use of the infrastructure topology and the useful bandwidth of the infrastructure. One method is through utilizing cable modem technology (Docsis) and hybrid fibre cable technology (HFC). Said object concerns especially utilization of the standard ITU-T J-222 (Docsis 3.0). One important object of the invention is to exploit existing infrastructure in order to provide an alternative to deployment of fibre connection all the way to clients. Said object aims to achieve this with smaller budgets, less inconveniences in general and with deployment paces that are considerably faster. Said object is at the same time to provide bandwidth which still is at least competitive to 100 Mbps fibre to the home (FTTH). In this context a basic object of the invention is to solve the particular difficulties concerned with discontinuity on client cables in power grids both in utility grids and in building grids. The object is correspondingly to solve said difficulties while avoiding that signals on the main line, from which the client lines derive, are not influenced by said discontinuity on client lines. In the same manner the object is to optimally exploit that the main lines or main cables individually, disregarding the distribution points, have relatively moderate discontinuity. The object is to exploit that there exists favourable continuity in between distribution points on main lines of power grids both with versions using low voltage and with those using medium voltage with distribution transformers. The object of the invention is further to facilitate remote metering for electricity and other types of meters where the invention can be deployed dedicated for such use however, including scaling up options all the way to triple play capacity. Said object concerns in particular remote metering and man to machine tasks (M2M) which it facilitates entirely across IP interfacing. The invention allows scaling through number of cables, frequency region widths, number of frequency channels, number of active distribution connections and at VLAN layers in various distribution points. A further object of the invention is to facilitate maximum possible bandwidth capacity along electrical infrastructure or similar infrastructure to provide bandwidth for nearly any purpose in need of communication bandwidth preferably over IP interfaces. For said object some of numerous examples are micro cell WIFI, Femtocell communication, TV surveillance, various tasks for surveillance, various objectives for redundant communication capacity. Summarized the object of the invention may be expressed as being identifying problems that caused a very large number of projects world wide within NoNewWire to fail with respect to stability and predictability. Further it is to contribute with novel solutions for the many parts that such systems are made up of in order to solve said problems. There are a number of other applications of the invention. Examples are utilization of overhead lines in railway systems and other rail or traversing based apparatus in order to obtain two way communication with stability and large bandwidth for moving objects across is shorter or longer distances. Corresponding applications of the invention emerges because existing infrastructure for railway and similar can be used for simple erection of dedicated metal wires for high speed communication where installation and complexity can be simplified compared to using their existing, metallic lines. Even further applications include use of waveguide similar infrastructures as with gas pipes, water pipes, sewer pipes, for example across shorter distances that otherwise would mean large infrastructure deployment budgets. A person skilled in the arts is liable to see still other applications of the invention.

### The Invention

The invention enables combination of inventions as in PCT/NO2006/00137 with equipment belonging to open standards as with Docsis and DVB without bit rates BER and jitter deteriorating quality for critical service stream applications noticeably when using problematic mediums where dispersive characteristics can be a consistent problem. The invention also makes it possible to accept available and favourable, proprietary standards.

The invention makes it possible to combine standards within the same system. The invention makes it possible to combine open and proprietary standards within the same system.

The invention makes it possible to apply recognized standards without interfering modifications and thus benefit from the advantages of said standards in terms of efficient production of telecommunication services in so called No New Wire concepts. The invention aims at facilitating standardized technology for use with the most critical service streams on alternative infrastructures or so called No New Wire that said technologies are not intended for.

The invention applies a synergy at the lowest layers of standardized communication systems as with Docsis and DVBc by using repeater based systems in power grids and thus avoiding packet losses and thus giving commercial quality for demanding services like IPTV with MPEG4. More precisely this concerns in particular link and physical layer of the OSI model. The repeater based system of the invention provides the carrier to noise ratio to stay nearly unchanged regardless of distance from Headend or from node points where the Headend signals are distributed. The invention can utilize that it is optional whether interconnections are made to the link layer or the physical layer. Further the invention can utilize the possibility to choose interconnection at link layer or physical layer at the different repeater positions. The repeater based system irrespective of said synergy thereby ensures a quality for service streams which is nearly identical to coaxial cable within a given frequency region. With the invention BER will only be acceptably higher despite different dispersion characteristics and variations in signal medium. The invention therefore facilitates through no or minor modifications of standardized equipment fully acceptable services, even the most demanding ones.

The invention involves novel solutions to offer required, efficient, industrial deployment to compete against more expensive, technology solutions.

The invention assures that input and output coupling which potentially is destructive for stability, connectivity and for Quality of Service can be done industrially, as do it yourself packages or as combinations thereof.

The invention ensures to a large extent that improvement of stability and Quality of Service are not disrupted across the last distance between the point at the customer premises where stable connectivity is established and the service nodes. One example is when stable connectivity to a broad band modem exists and the local connection is to a digital TV set through wireless routers or through power line adapters like HomePlug.

With one embodiment of the invention isolation between differentially connected lines is improved using a physically small matching unit with short physical distance from the wires that are differentially coupled. The invention achieves isolation with impedance in series with each of the differential conductors as well as a low shunt impedance between said conductors where the shunt impedance in its simplest form consists of a capacitor. In a number of embodiments of the invention the serial impedance is made up of clamp on ferrite toroids or dielectric toroids as when they solely consist of the inductance of an insulated conductor. Said inductance for relatively short conductors may yield impedances of one hundred micro Henry or more. The differential conductors in power grids will usually be two out of two, three or four electrical conductors. The invention also uses differing frequency bands for full duplex for downstream and upstream signals on mail lines from where the various client cables are distributed or on main cables distributed from the first main cable. One embodiment of the invention uses a third frequency band for client cable, riser or consumption cable between junction point node and consumer or client. In some embodiments of the invention it can be satisfactory to use half duplex communication where some embodiments of the invention can apply standard power line spread spectrum as OFDM based units (HomePlug) that use half duplex in the frequency region 2 to 30 MHz.

The invention makes it possible to increase bandwidth for systems with a number of cables in the same junction point that with a number of embodiments of the invention achieves signal isolation between them. Said number of cables with signal isolation can then carry differing signals within the same frequency region without noticeable interference between them. This can apply to signals with identical information as with real time protocols or signals with differing information as with Internet traffic or differing IPTV signals. Examples of said application of none identical signals on different cables in the same junction point are transformer stations in utility power grids, junction boxes or street junction boxes, junction points with overhead cables, panels and cable junctions in buildings, industry and communication infrastructure. The invention facilitates that the said carrying of differing signals can happen without cross talk reducing signal to noise ratios to any noticeable degree that could reduce bandwidth or increase bit error rate. In certain embodiments the invention utilizes that the main cable from where riser cables depart uses separate frequency bands for downstream and upstream. Thus the invention enables full duplex along the main cable or main line and thus also makes it possible to utilize same frequency gain by keeping the loop gain negative. The invention thus achieves minimum collision problems along the main cable or main line and thereby avoids client lines affecting capacity on the main cable meaning that the capacity on the main line does not depend on the capacity of the client lines. With the help of A/D, D/A interfaces in repeaters at junction points the invention with certain embodiments will use secondary protocols out to the clients or consumers from the junction points that are located along the main cable. On account of the isolation towards other lines connections on the riser or client line may be half duplex without noticeable effect on the system in general. A significant characteristic of the invention is avoiding signals passing parts of the infrastructure that deviates from resembling transmission lines. Said characteristic means that signals only must pass along cables or lines and that they have to be coupled in and out without being coupled into structures that do not behave as good transmission medium. Thus the useful bandwidth with the invention is increased dramatically, among other from reduced parasitic impedances. Thus upper frequency limit for useful frequency spectrum is increased. At the same time said, important characteristics of the invention offer improved symmetry which again reduces cross talk coupling, lower emission levels and improved immunity. The invention achieves this while retaining minimum obstruction of operation of the infrastructure in general. In certain embodiments of the invention the system analog bandwidth is increased through utilizing maximum bandwidth by amplifying the signals without frequency transposing. In certain embodiments of the invention the enlarged bandwidth is exploited by dividing available analog bandwidth into several frequency bands by which the invention allows low cross talk levels. In certain embodiments of the invention passive bypass coupling schemes become possible for junction points where it is not required to distribute signals. Correspondingly the invention facilitates simple installation of active bypass couplers that carry amplifying repeaters for at least one direction in said junction points where purpose of said repeaters is to maintain the signals and retain immunity which is of special value with overhead cable networks.

The invention exploits that within the infrastructure there is electric connections with short distances in between allowing conditioning of signals to avoid loss of signal quality and detainment of parameters like immunity. The invention is therefore aimed at meeting the significant, both practical and electrical obstructions presented by the discontinuity within the infrastructure. The invention exhausts the fact that the infrastructure may have favourable characteristics for signal transmission in between infrastructure elements that represent discontinuity. Numerous embodiments of the invention will attain as large bandwidths all the way to the client or user as to require the main junction points as in substations (small transformer stations) to offer lighted or dark fibre access within them in order for available bandwidth to be exploitable all the way to the client. A number of embodiments of the invention will carry said fibre access as part of a fibre ring system. The invention enables extending deploying fibre even closer to the client as all the way to one or several of the junction points along the main lines. Thus more bandwidth can be fed into the junction points. Again, more bandwidth can be distributed to the clients across the last distance with electrical signals through as is an example A/D and D/A and OFDM modulation. Some embodiments of the invention can in similar manner as with said extending deploying fibre utilize coaxial cable in parts of the system belonging to the invention in order to increase bandwidth towards fibre ring. Some embodiments of the invention can apply a synergy of said solutions for deployment of fibre access. A number of embodiments of the invention utilizes that there is little discontinuity along each main line path by making the communication on said paths as much as possible independent of communication on distribution lines. Thus the invention achieves that communication along the complete main line becomes stable and predictable. In a number of embodiments the invention assigns a dedicated frequency band for distribution lines (risers). In said embodiments of the invention all distribution lines share the same frequency band. In said embodiments of the invention isolation is provided between lines to ensure that the respective distribution lines avoid interference with each other. Said avoiding interference is based on achieving required isolation between distribution lines that is sufficient to offer satisfactory signal dynamic for each individual distribution line. Typical requirement for the dynamic range for the distribution line (riser) will be 30 dB for 256 QAM plus cable attenuation as average 15 dB amounting to 45 dB. With said dynamic range or narrower or wider dynamic ranges certain embodiments of the invention provide avoidance of packet collisions or carrier detections in between distribution lines with half duplex communication irrelevant of PHY on the respective distribution lines having signal dynamics larger than isolation between the lines (risers). Some embodiments of the invention provide certain, dedicated Quality of Service (QoS) for communication on distribution lines aimed at maximum utilization of the bandwidth on the distribution line in favour of the most demanding protocols as UDP and independent of communication on the main line or on other distribution lines. Further the invention facilitates application of remote metering for electricity and other types of meters, thus the invention can be deployed dedicated for such objectives but yet retain scaling up options all the way up to full triple play capacity. In some embodiments of the invention the client unit communicating over the distribution line from the main line is integrated into the meter unit incorporating filtering of noise from dwelling, apartment or similar. Said applications in particular serve the objective of remote metering and Man to Machine (M2M) tasks done entirely across IP interfaces. A further objective (embodiments) is to facilitate maximum bandwidth capacity along electric infrastructure which generally exists everywhere. Said objective (embodiments) is valid also for similar infrastructure and for making bandwidth available for nearly all that needs communication bandwidth preferably over IP interfaces. Examples of said embodiments are microcell WIFI, Femtocell communication, TV surveillance, various tasks for status monitoring, various types of redundant communication capacity.

### SHORT DESCRIPTION OF THE FIGURES

FIG. 1 shows by clock diagram how the invention applies a synergy of the lowest layers in standards for telecommunication.

### DETAILED DESCRIPTION

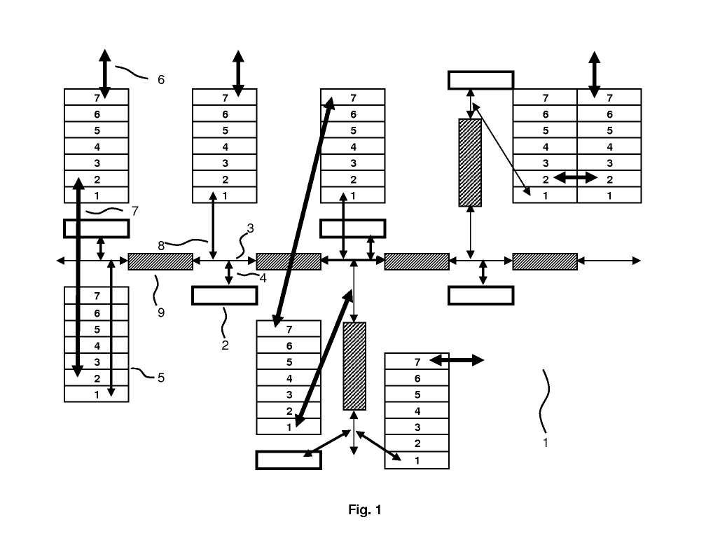

In FIG. 1 it is shown that the invention, consisting of infrastructure 9, with junction points 3 between segments 9 of infrastructure are connected 4 to repeaters 2 and that equipment 5 from standards for telecommunication is coupled together on link layer 7 of OSI model and on physical layer 8 and standards are coupled together on layer 6 higher than link layer.

The invention combines different standards in different ways through connecting the standard to link layer or physical layer. If the invention is to apply the same modulation type as the standard, it is usually optimal to connect directly to the physical layer of the standard, if necessary through frequency transposing. Through connecting to link layer the invention can utilize a different type of modulation which favourably can belong to a second standard. Said modulation can also be implemented within the repeater of the invention. Repeater can be part of signal hub as described in PCT/NO2006/000137 with pertinent publications. In said signal hub signals that use same frequency band in both directions can be split into several frequency bands for differing frequencies for differing directions. The invention then can achieve individual signal processing for different directions and lines based on the existence of isolation between directions and lines that are utilized. In certain embodiments of the invention can utilize different modulation types in different parts of the system without the upper layers of the communication protocol suffering noticeable delays or have effects. The objective of using different carrier frequencies, different modulation types and different communication layer interfaces is primarily to optimize results. Said optimization will depend on the varying characteristics of the information carrier or infrastructure related to said characteristics for the particular path or part.

The invention allows signal hub and client units as described in PCT/NO2006/000137 with pertinent publications to be realized with demodulator—modulator at any point in the system. The invention can also utilize available isolation between lines using signal hub embodiments corresponding to said publication. In various embodiments of the invention lines can be customer lines departing from junction boxes or poles in low voltage power grids and in other embodiments lines may be risers of a low voltage transformer station (substation). Thus signals are prevented from disturbing each other on the various lines. Said signals are also prevented any direct connection with each other. Said signals can then also exploit the total available analog bandwidth on each individual line, in example by each line having a dedicated demodulator. Another example of system solutions with the invention is to use modems in combination with available products that modulates and demodulates using a different modulation and protocol. Thus the invention can allow the connection between modem and said product take to be realised on a higher layer than the link layer as with IEEE 802.3. In a main distribution point this is likely to be a Gigabit interface. In said example delays will be acceptable because the interface is not shared or is shared only by a few users or services. Among many of the invention advantages is that Master Slave units at moderate costs can be applied because the slaves due to the signal hub described in PCT/NO2006/000137 and pertinent publications only can communicate with the master. In one embodiment of the invention several master units are used on the separated lines or each of several masters has signal coupling to two or more of the separated lines. Satisfactory exploitation of the isolation between user lines can be secured through individual control of gain and attenuation as described in said publications.

One example of embodiment of the invention is use of cable modem Docsis from Headend and in difficult cases application of modems and HomePlug or xDSL Master from main line across riser and to client. In said embodiment the modem can be Dosis 3.0 which contains several physical modems. Another example of embodiment of the invention is use of Docsis modular Headend (M_CMTS) for Edge QAM where the interface for Edge QAM is used for modulation with OFDM modulation. Said OFDM modulation can consequently in one embodiment of the invention be transmodulated back to QAM with the client for consequent application of a standard, low cost cable modem.

The invention contributes to industrialization and commercialization by facilitating so called “do it yourself” packages that can be distributed to customers for installation in apartments in MDU's and houses without installation personnel having to enter the premises. To secure a highest possible success rate of said packages an embodiment of the invention also has connections between different interfaces at different communication layers. The invention exploits in an embodiment for power grid communication the fact that a high noise level in dwellings or apartments has negligible impact on the return transmission when excitation powers favourably are 0 dBm or more. Thus an embodiment of the invention may use said return transmission through a customer unit coupled to an electric outlet in the home, preferably as close to the electricity intake or fuse panel as possible. Said customer unit will in an embodiment of the invention be coupled to the downstream signal on a higher frequency less prone to noise. At the electricity intake or the fuse panel an embodiment of the invention uses a secondary customer unit which allows the return signal to pass passively through with little attenuation. Alternatively said customer unit may actively upconvert said return signal for efficient re-coupling using none galvanic coupler. Said customer unit is arranged as to receive the downstream signal through a loose coupling which as with one embodiment of the invention can be installed by the customer. Said loose coupling can be inductive or capacitive, none galvanic coupling and include a filter against the power grid, possibly consisting of the electricity meter, against the home power grid. Said downstream signal is frequency upconverted to a second frequency which the primary customer unit uses for reception. Said primary customer unit can then favourably be coupled directly to an open standard modem or contain a device corresponding to said modem. Said primary customer unit can favourably contain frequency transposition to stay compatible with said modem. Said solution with two customer units can also be an installation performed by professionals as part of positioning connections for modem and Ethernet interfaces farther away from electricity intake or fuse panel. To improve said solution and to increase the distance between electricity intake and connectivity point the invention can utilize arrangements on the electricity cable in use for the purpose. Said arrangements equip the cable outlets with arrangements that prevent low voltage loads connected to said electricity cable to disturb its symmetrical, differential characteristics. In an embodiment of the invention said arrangement consists of a cover plate with male and female contacts or female to male plug that is inserted into the outlet. In an embodiment of the invention said cover plate or plug contain ferrite toroids with air gap and capacitive shunts for the differential signal. Said embodiment thus can prevent that electric loads can affect the signal properties of the electric cable of the invention. Said arrangement with cover plate or plug for electricity outlets in an embodiment of the invention can also be used to relay the signals between customer units and any position in the home. Said relaying of signals can in an embodiment of the invention take place with connections to the upper layers of the communications protocols used. The specific one used from said protocols within the home is in an embodiment of the invention HomePlug or HomeAlliance including the physical layer transmitted on the electricity circuit within the home. A certain version of said embodiment for electricity outlets is a cable with plugs at both ends designed to interconnect two different electricity fuse circuits with respect to signals and to act as galvanic barrier for low voltage electricity. Said embodiment for electricity outlets is in an embodiment of the invention also a mechanical and electric supply host for radio devices that may serve any purpose. Said embodiment of the invention is in a further embodiment arranged as to frequency transpose signals for said radio device to more suitable frequencies that can utilize said electric cable improved signal properties by transmission of said suitable frequencies on electricity cables in various parts of the home. In certain embodiments of the invention the customer unit communicating with the node at the main cable of the power grid is connected to an electricity outlet following the fuse panel for both transmission directions provided that the most demanding data protocols are not to be used.

In an embodiment of the invention industrial use is prevented from suffering substantially from problems with inefficient installation related to connections to cables within the power grid, both outdoor, within buildings and in homes. With said embodiment of the invention the problem is solved using geometric, symmetric connections in tight compartments using low current connection clamps. Said clamps in the simplest embodiment of the invention consists of a plastic bundling strip around the insulated conductor. A contact screw in the said bundling strip forms electrical contact between the cable conductor and a signal wire.

In embodiments of the invention using naked wire as well as medium the invention exhausts very low losses along the wire as compared to spherical losses of a radio link budget. Even across insulators in masts the losses may be negligible due to the wires on each side working as couplers to each other. Even with embodiments of the invention using overhead electric lines for powering of electric locomotives of railways, said low losses persist for appropriate carrier frequencies. Correspondingly an embodiment of the invention uses thin wires stretched along roads and streets using such as street light poles. Said embodiment can be for wireless coverage. In certain embodiments of the invention two or more frequency bands with relatively wide spacing are used. In said embodiments this is used in order to introduce redundancy with respect to snow and ice on the wire. Using transmission on said wire the invention reduces influence from multipath interference which has considerable impact on stability. The invention exploits said low line losses by accepting less efficient input and output coupling for repeaters and transponders that are installed on the line. The invention can therefore be satisfied with the use of standard antenna concepts as probes installed near the line. Correspondingly, certain embodiments of the invention can be satisfied with a simple, direct coupling to the wire. Said direct coupling is especially applicable on low voltage, naked wire or on ground wires with mast overhead systems. Despite the input and output coupling loss using said coupling adds up considerably and enjoys decrementing significance with distance due to the line losses being low compared to free space loss, reduced Fresnel zone losses or line of sight losses with radio links. Thus in various embodiments of the invention repeaters become simple and low cost. In one embodiment of the invention radio units made for radio link can be installed in a suitable encapsulation directly on the line with proper spacing between repeaters. In an embodiment of the invention coupling to wire is achieved with the antenna supplied with the radio device. Thus the invention enables use of standards without making interface connections at physical, link or other layers when configuring of radio devices for said standards as repeaters is possible and time delays do not represent a major problem. One example of this embodiment of the invention is Zigbee radio devices installed in suitable encapsulations on the line. Other examples of this embodiment of the invention are correspondingly installation of 802.11x radio devices. Said embodiments of the invention constitute significantly reduced immunity problems in shared frequency bands and reduce the needs for exhausting Mesh and other dynamic topologies. In an embodiment of the invention said advantages are exploited by erecting metal wires dedicated for applications of said embodiments of the invention. In such embodiments of the invention can achieve a hundred percent stability and connectivity, enabling Quality of Service even for real time protocols despite none line of sight, room and floor barriers in buildings and homes. The metal wires in certain embodiments of the invention can be made very thin or nearly invisible as by using nylon wires with thin layer of metal. In an embodiment the wires can be made decorative as by being lighted. In certain embodiments of the invention it is necessary to use transponders on or close to the line to establish link with wireless devices via input and output coupling to the line. In other embodiments of the invention the radiation loss is sufficient to establish coupling and stable link to wireless devices that without said line do not necessarily achieve connectivity at all. Like with naked wire simple antenna concepts can work as probes for infrastructure that is capable of working as waveguides, in particular pipe shaped infrastructure made of plastic or metal. In an embodiment of the invention input and output coupling of a microwave radio installed adjacent to a plastic pipe that works as waveguide on account of plastic to gas contrast, plastic to liquid dielectric contrast or plastic to solid matter contrast. In embodiments of the invention in terrain where low voltage power is unavailable the invention uses various solutions for supply of energy for the repeaters, transponders, signal hub, routers, bridges and access points required for the system. In one embodiment the invention uses solar cells as source together with chargeable battery. In another embodiment of the invention industrialized, toroid based power supplies for overhead power lines are used. In yet another embodiment of the invention electrostatic probes with galvanic barrier to adjacent high voltage lines feeds an electronic power supply unit. In an embodiment of the invention said probes can be made up of shielded high voltage cable where the shield of a certain length is utilized for power connection. In said embodiment the cable is generally treated as with a standard termination with respect to insulation, leaking currents and water resistance. In an embodiment the invention uses probes made up of wire or metal rods. In still another embodiment of the invention with high current loads present, an inductive loop at a suitable spacing from the high voltage conductors is used. Further, in an embodiment of the invention it uses a transformer in the form of a toroid core encircling the high voltage conductor which works as a single turn primary winding. Said transformer contains in addition to a secondary winding a winding that short circuits the transformer where the short circuiting is switched at a high frequency by an electronic device. Said electronic device may be powered by the transformer but can in one embodiment of the invention additionally receive start-up energy from battery and solar cell in order thereafter to keep itself running. Said toroid core should preferably be saturated by the current passing through said high voltage conductor. Numerous embodiments of the invention use a small matching device that couples through differential coupling through two, short leads that are connected to two conductors of a cable. Said connection is made with the help of compact cable clamps that allow coupling as close as possible to the point where the said conductors of said cable spread out for termination at the junction point. Said two short leads should not extend much beyond 10 cm to allow them to be tuned and to exploit the useful bandwidth of as an example 100 MHz. Said two short leads inductance is brought to resonance at the highest possible frequency for the cable in question with the help of a capacitor in the matching device. Thus the said capacitor forms a pi filter matching network together with the lead impedances and stray impedances. Said two short leads are connected within the matching device through individual high voltage capacitors that provides barrier to the coupled cable carrying voltage. The cable impedance that often will be in the region of 30 to 40 Ohms, is transformed in the matching device to a suitable impedance for the signal cable. Said signal cables protrudes from the matching device and to the unit it is destined to connect to and said signal cable can be a standard telecommunication cable with twisted pairs. In some embodiments of the invention the matching devices and the shunt devices are each equipped with an indicator lamp to indicate galvanic contact to the power cable and to ease installation and for later checking purposes. In an embodiment of the invention the matching device is also equipped with components that bypass surge voltages passed delicate components within the matching device as is important in air cable grids. In certain embodiments of the invention the matching device contains choke filter contact between the voltage carrying side of said matching device and a cable destined for supplying power to active devices associated with the matching device. In said embodiments of the invention said matching device contains at least one common mode choke. In some embodiments of the invention said matching device includes high frequency transformer providing galvanic barrier to improve bypassing of said surge voltages passed its signal components. The invention consists of arrangements for signal isolation. To achieve maximum isolation between lines of the main line the respective, two matching devices for the main line can be connected to differing pairs of said main line cable. In numerous embodiments of the invention shunt impedance is installed in association with each matching device. Thus the invention achieves improved isolation. An example of said improved isolation is unwanted coupling that has to travel through at least three filter sections. Firstly it will consist of inductance. Said inductance can be ferrite cores installed on at least two conductors. Then at least one shunt impedance. Then inductance of conductors or rails, then at least another shunt impedance and lastly again impedance that may be made up of ferrite cores on at least two conductors. In certain embodiments of the invention the shunt impedance in stead of capacitor with short connecting leads can be made up of a filter network. Said network consists of capacitors and lead inductances to achieve lower shunt impedance for higher frequencies. Said low shunt impedance is achieved through wide band series resonance with the aid of the inductance of the connecting leads of the shunt impedance. Said connecting leads of the shunt impedance thus in some embodiments of the invention can consist of a number of insulated leads that with the aid of a capacitor network and mutual lead inductance provide series resonance across several decades of frequency. The capacitor network may consist of ceramic capacitors with low test voltages because the shunt device will also include a series high voltage capacitor as barrier against the 50 or 60 Hertz voltage. Said embodiments of the invention arranged for signal isolation provides protection against damages caused by surges on the main line including associated consumers getting improved protection against damages caused by surges. The differential conductors of a power grid infrastructure where the invention is applied will usually consist of two from two, three or four electricity conductors. In some embodiments of the invention two and two conductors in a four conductor system may be used for more efficient differential transmission. The invention applies differing frequency bands for full duplex downstream and upstream signals on the main cable from where the various customer lines are distributed. In some embodiments of the invention each band is further divided into frequency bands or channels to achieve a constant bit rate in each channel. The lowest channels in a ground cable system will exhibit dynamics of 5 to 20 dB between repeaters, while the highest channels that the invention facilitates use of will have dynamics of 20 to 40 dB between repeaters. In air cable systems corresponding figures will be 2 to 5 dB and 10 to 30 dB. Thus the invention facilitates use of more effective modulation as with 256QAM and 1024QAM on a continuous basis. Thus the invention achieves redundancy in that all junction points and distributions can have several options for channel selection to achieve stable bit rate into the distribution points. The invention can achieve this directly by applying cable modem technology on the main line as with four downstream channels placed shoulder to shoulder as well as a number of upstream channels also placed shoulder to shoulder. In distribution points some embodiments of the invention have installed cable modems that again are connected to a communication device. Said communication device has a different communication protocol and different PHY and can have bridge functionality at MAC layer with PHY using OFDM spread spectrum modulation and using half duplex as in power line devices (HomePlug). In said embodiment of the invention it will serve the purpose to use one cable modem and one OFDM power line device for each distribution line (riser). In certain embodiments of the invention it may be sufficient to use one cable modem at the distribution point connected to a switch or router which again is connected to several of said power line device using one power line device for each distribution line. In said embodiment of the invention each distribution line can be part of a VLAN using a standard which supports Quality of Service and IGMP. Correspondingly an embodiment of the invention is using a cable modem at the distribution point according to the cable modem standard ITU-T J222 (Docsis 3.0). Thus the invention achieves being able to bundle several channels at various levels including MAC layer for maximum bandwidth and VLAN towards the distribution lines. The invention facilitates increasing bandwidth in systems with a number of cables at the same distribution point which in many embodiments of the invention retain mutual signal isolation. Said cables with signal isolation thus can relay different signals within the same frequency band aided by coupling using said matching devices and isolation using ferrite toroids and shunt impedances. As frequency bands for input coupling are the same on respective cables and since frequency bands for output coupling are the same the invention achieves isolation between the cables sufficient for 40-50 dB dynamics. This is adequate dynamics even for constant, none adaptive modulation with up to 1024 QAM as long as PHY does not use half duplex with carrier detection and collision avoidance using large dynamics. Examples of said use of different signals on different cables at the same distribution point are transformer stations (sub stations) in utility power grids including mast mounted transformer stations. Further examples are distribution points in junction boxes, street junction boxes, distribution points in air cable systems, panels, cable distributions, fuse panels in buildings, industry, communication infrastructure, homes, apartments. The invention in certain embodiments utilizes that the main cable from where distributions take place apply separate frequency bands for downstream and upstream signals despite that the available analog bandwidth is marginal. Thus the invention enables use of full duplex along the main cable or main line to achieve maximum stable downstream bandwidth. Thus the signals can also be amplified on the same frequency for maximum exploitation of the cable bandwidth. In certain embodiments of the invention duplex filters are applied that have cut-off steepness of maximum a few Megahertz. Said duplex filters have high stop band suppression to keep loop gain sufficiently negative. Said loop gain is kept is kept sufficiently negative in opposition of internal loop coupling within repeaters, external loop coupling through devices consisting of said matching devices and said arrangements for signal isolation and marginal analog bandwidth compared to the transmission speeds to be acquired. With 40-50 dB isolation stable same frequency gain may reach 25-40 dB depending on which type of same frequency gain that is used. Thus the invention achieves coherent gains with the lowest possible levels of phase noise and beating as well as dynamic range only limited by the loop gain. In certain embodiments of the invention remote controlled pre-emphasis, de-emphasis and equalization is used to maintain control of negative loop gain, gain and stability, especially during deployment and installation but sometimes also favourably during operation. In certain cases as with air cables where positions for installation of repeaters are available everywhere some embodiments of the invention need only 10-15 dB net gain. Said gain applies to the highest frequencies while the lowest frequencies with least losses said net gain can even be negative and passive. In some embodiments of the invention passive bypass couplings between at least two main lines in a junction point where no distribution lines are desired can be realized. Said bypass coupling is done by connecting together two of said signal cables from two of said matching devices. Said bypass coupling will typically be applicable in air cable systems. Correspondingly the invention simplifies installing bypass couplings that have amplifying repeaters for at least one direction in said distribution points to maintain the signals and immunity as is of particular value in air cable systems. In some embodiments of the invention said passive bypass method is used with half duplex communication technology of standardized or proprietary type. In certain embodiments of the invention said bypass is realized as a passive hub where also distribution lines are included.

In several embodiments of the invention one frequency band is dedicated to distribution lines and in some embodiments. At the same time lower effective bandwidth due to OFDM has less significance because the distribution line will virtually have the whole frequency band at disposal without bandwidth reduction caused by other distribution lines using the same frequency band. For 2-30 MHz this could mean more than 200 Mbps speeds with favourable conditions. Typical requirements for dynamics on the distribution line will be 30 dB for 256 QAM plus cable loss which as average is 15 dB. With said dynamics or less dynamic range some embodiments of the invention provide avoidance of packet collisions or carrier detection between distribution lines with half duplex communication. Said collisions or detection could be caused by the dynamic range of the PHY on each distribution line exceeding the isolation between the lines. In certain embodiments of the invention using half duplex power line devices said avoidance is achieved by giving identical devices clock frequencies that are slightly different. Thus it is achieved that carrier detection and collision avoidance functions do not use resources which could give mutual interference between distribution lines despite their operating in the same frequency band and despite the signal dynamics being larger than the isolation between lines. At the same time adaptive modulation will work normally and offer robustness against noise and tolerance to variations in cross talk levels. In certain embodiments of the invention the communication frequency band on the distribution line is split. In certain embodiments of the invention this is done by upconverting part of said frequency band to a redundant channel that is above the highest frequency band which the main line uses. Thus it is achieved that the complete frequency region that the main line uses is moved lower in frequency as when the main line consists of cables with poor high frequency properties or long cable paths in the ground. In certain embodiments of the invention said upconversion takes place only in one signal direction from the distribution point in order to avoid generating interference into the main line. In other embodiments of the invention said upconversion takes place in both directions.

1. Signal repeater system for power grids with one or more main cables that have distribution cables for consumers, comprising:
a signal repeater system on each main cable facilitating PHY and protocol for full duplex communication comprising nodes in distribution points along said main cable
where at least one of said nodes are facilitating at least one modem for said duplex communication
wherein said modem has an interface facilitating connection to secondary communication devices at said nodes.

2. The signal repeater system according to claim 1,
wherein at least one of said nodes to be forward coupled to a consumer distribution line through an IP interface and a spread spectrum PHY using half duplex.

3. The signal repeater system according to claim 1,
wherein communication on said main cables are to use cable modem technology along the main cables including to and from said node points.

4. The signal repeater system according to claim 1,
wherein capacity on said main cables is scalable.

5. The signal repeater system according to claim 1,
wherein capacity on said distribution lines is scalable.

6. The signal repeater system according to claim 1,
wherein client unit to be built into electricity meter.

7. The signal repeater system according to claim 1,
wherein client unit is to be combined with fuse panel.

8. The signal repeater system according to claim 1,
wherein client unit to be installed by client outside of fuse panel.

9. The signal repeater system according to claim 1,
wherein bandwidth capacity at said node points to be made available as redundant data capacity for any purpose.

10. The signal repeater system according to claim 1,
wherein coupling to said main cables and said distribution lines are to be made using a matching device and coupler which is installed closest to and adjacent to cable using compact clamps separated from high frequency discontinuity and using signal cable for further signal coupling and using built in indicator lamp to indicate proper coupling to said main cable or said distribution cable.
